(19) United States
(12) Patent Application Publication
(10) Pub. No.: US 2002/0177416 A1
(43) Pub. Date: Nov. 28, 2002

(54) Radio communications device

(75) Inventors: Kevin R. Boyle, Horsham (GB); Antonius J.M. De Graauw, Haelen (NL); Roger Hill, Horley (GB); Peter J. Massey, Horley (GB)

Correspondence Address: Corporate Patent Counsel, U.S.Philips Corporation, 580 White Plains Road, Tarrytown, NY, 10591, US

(73) Assignee: KONINKLIJKE PHILIPS ELECTRONICS N.V.

(21) Appl. No.: 10/150,826

(22) Filed: May 17, 2002

(30) Foreign Application Priority Data
May 25, 2001 (GB) 0112747.1
Dec. 11, 2001 (GB) 0129544.3

(51) Int. Cl. H04B 1/40

(52) U.S. Cl. 455/82; 455/77

(57) ABSTRACT

A radio communications device, such as a mobile phone or Bluetooth device, comprises a ground conductor (302) incorporating a slot (304) and means (308) for coupling a transceiver to the slot to enable the ground conductor to function as an antenna. Such a device enables efficient radiating performance to be obtained from a significantly smaller volume than known antenna arrangements.

In one embodiment the ground conductor (302), slot (304) and transceiver are integrated in a module (206), which module is adapted for connection to a further ground conductor which provides the majority of the antenna area. The further conductor would typically be a printed circuit board ground plane or mobile phone handset. Matching and broadbanding circuitry may conveniently be incorporated in the module. By varying the area of the connections between the module and the further ground conductor, the resonant frequency of the slot (304) can be modified.

The present invention relates to a radio communications device comprising a ground conductor and a transceiver, and further relates to a radio communications apparatus including such a device.

Wireless terminals, such as mobile phone handsets, typically incorporate either an external antenna, such as a normal mode helix or meander line antenna, or an internal antenna, such as a Planar Inverted-F Antenna (PIFA) or similar.

Such antennas are small (relative to a wavelength) and therefore, owing to the fundamental limits of small antennas, narrowband. However, cellular radio communication systems typically have a fractional bandwidth of 10% or more. To achieve such a bandwidth from a PIFA for example requires a considerable volume, there being a direct relationship between the bandwidth of a patch antenna and its volume, but such a volume is not readily available with the current trends towards small handsets. Hence, because of the limits referred to above, it is not feasible to achieve efficient wideband radiation from small antennas in present-day wireless terminals.

A further problem with known antenna arrangements for wireless terminals is that they are generally unbalanced, and therefore couple strongly to the terminal case. As a result a significant amount of radiation emanates from the terminal itself rather than the antenna. A wireless terminal in which an antenna feed is directly coupled to the terminal case, thereby taking advantage of this situation, is disclosed in our co-pending International patent application WO 02/13306 (Applicant's reference PHGB010056). When fed via an appropriate matching network the terminal case, or another ground conductor, acts as an efficient, wideband radiator.

An object of the present invention is to provide a compact antenna arrangement for a wireless terminal.

According to a first aspect of the present invention there is provided a radio communications device comprising a ground conductor incorporating a slot, and means for coupling a transceiver to the slot, thereby enabling the ground conductor to function as an antenna.

The slot enables efficient coupling of the transceiver to the ground conductor, while the dimensions of typical ground conductors in wireless terminals such as mobile phone handsets provide a wide radiating bandwidth. In a device made in accordance with the present invention, the area which must be kept clear of components to avoid interfering with or interference from an antenna is much smaller than with known antenna arrangements.

The ground conductor and associated slot may be incorporated in a module for mounting on a further ground conductor, such as a printed circuit board ground plane. This arrangement has the advantage that the feed can be precisely controlled within the module while the further ground conductor provides a larger radiating area. Such a module can also be made significantly smaller than known antenna solutions and additionally including transceiver circuitry within the same volume.

Matching circuitry may also be incorporated within the module. A device made in accordance with the present invention is particularly suited to driving via a broadband matching circuit. Dual and multi band matching circuits may also be incorporated.

Polarisation diversity may be achieved, from a very small volume, by the addition of a PIFA to a device made in accordance with the present invention.

According to a second aspect of the present invention there is provided a radio communications apparatus including a device made in accordance with the first aspect of the present invention.

The present invention is based upon the recognition, not present in the prior art, that the impedances of an antenna and a wireless handset are similar to those of an asymmetric dipole, which are separable, and on the further recognition that the antenna impedance can be replaced with a non-radiating coupling element.

Embodiments of the present invention will now be described, by way of example, with reference to the accompanying drawings, wherein:

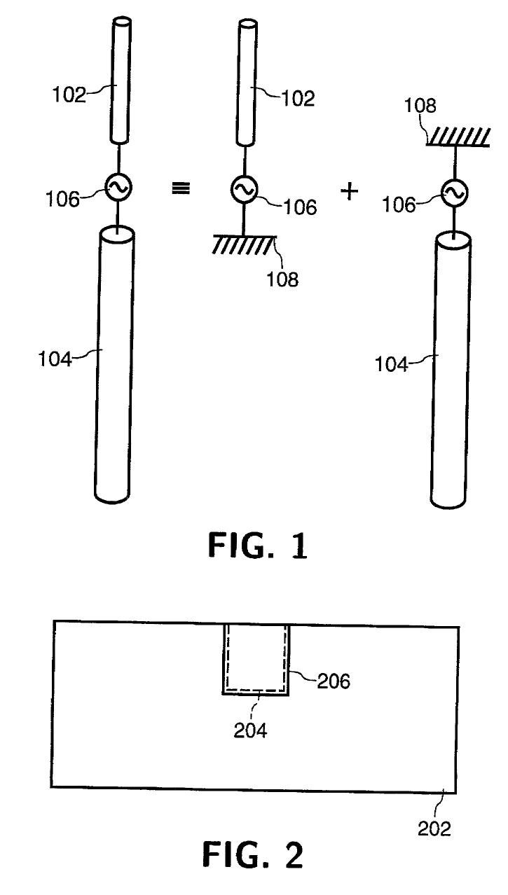

FIG. 1 shows a model of an asymmetrical dipole antenna, representing the combination of an antenna and a wireless terminal;

FIG. 2 is a plan view of a Radio Frequency (RF) module mounted on a ground conductor;

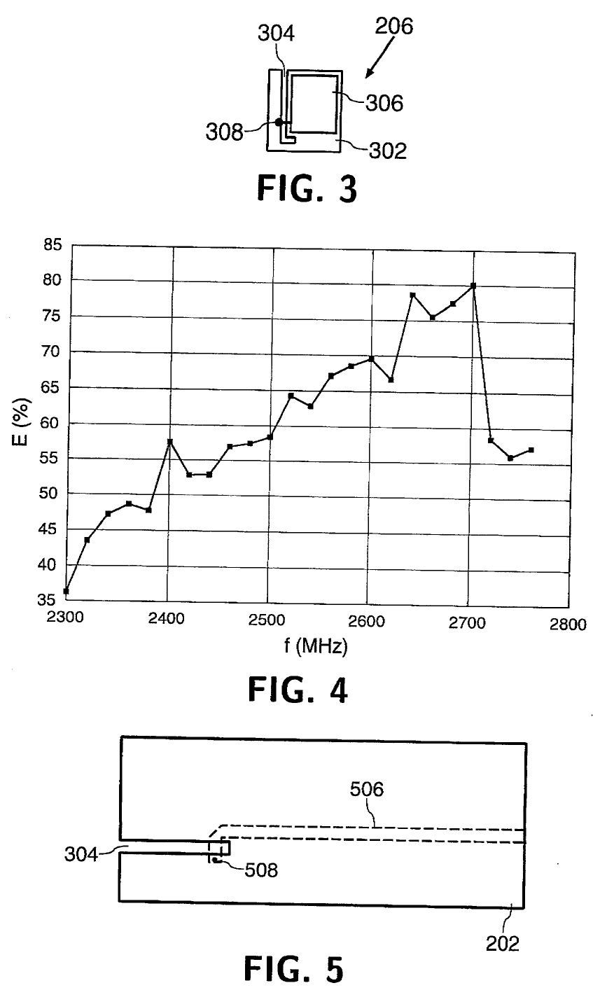

FIG. 3 is a plan view of an RF module comprising a slotted ground plane;

FIG. 4 is a graph of measured efficiency E against frequency f in MHz for a configuration similar to that shown in FIGS. 2 and 3;

FIG. 5 is a plan view of a test piece comprising a slotted PCB ground plane fed by a microstrip line;

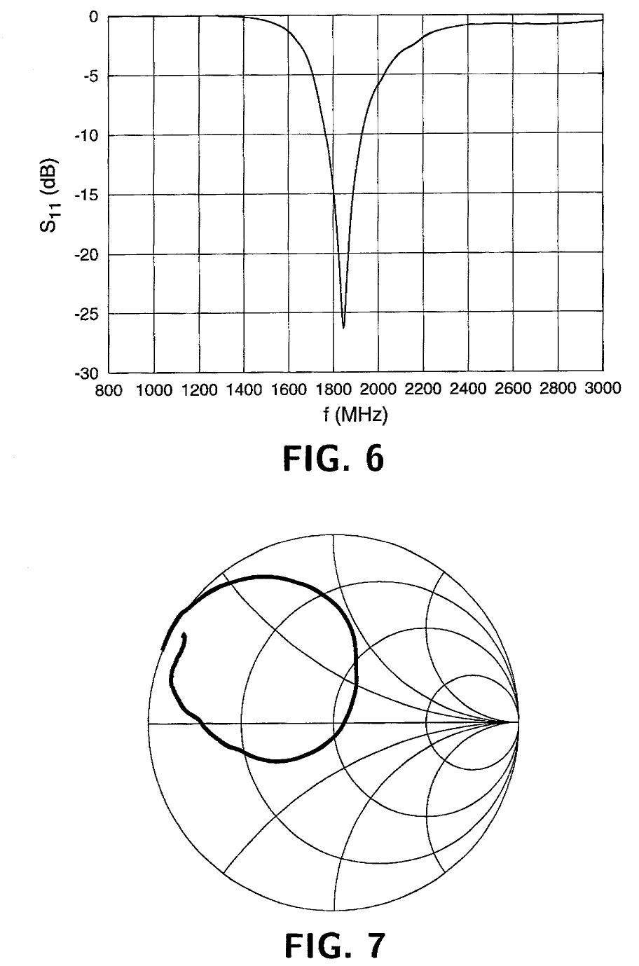

FIG. 6 is a graph of measured return loss S₁₁ in dB against frequency f in MHz for the test piece shown in FIG. 5, without matching;

FIG. 7 is a Smith chart showing the measured impedance of the test piece shown in FIG. 5, without matching, over the frequency range 800 to 3000 MHz;

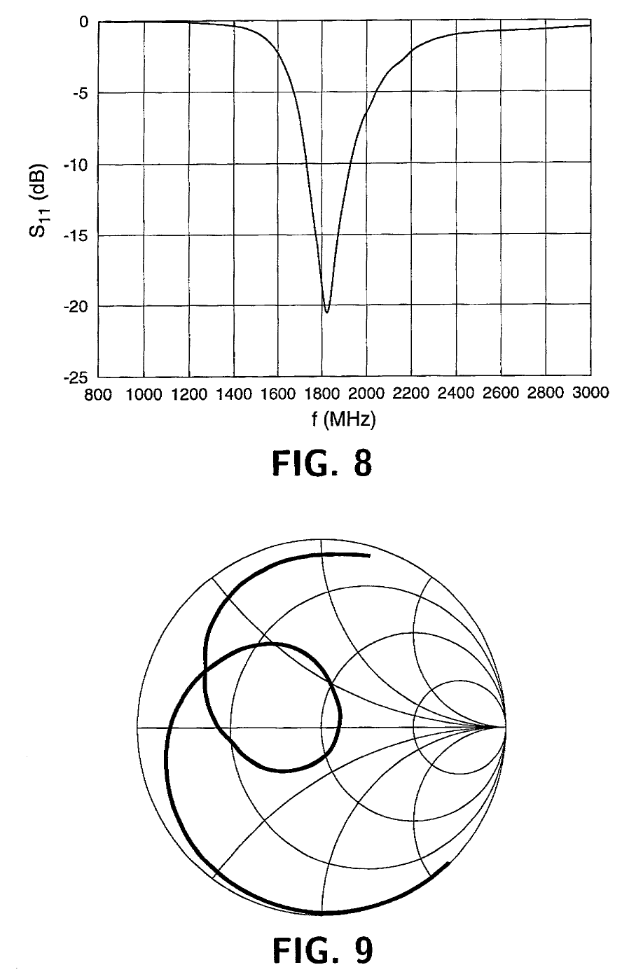

FIG. 8 is a graph of measured return loss S₁₁ in dB against frequency f in MHz for the test piece shown in FIG. 5, fed via a series LC matching circuit;

FIG. 9 is a Smith chart showing the measured impedance of the test piece shown in FIG. 5, fed via a series LC matching circuit, over the frequency range 800 to 3000 MHz;

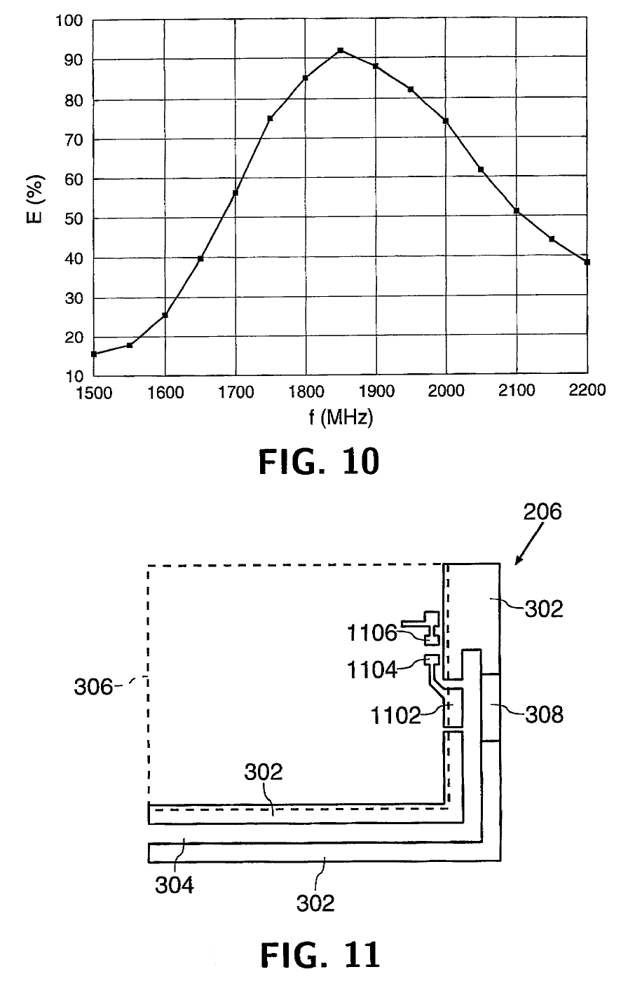

FIG. 10 is a graph of measured efficiency E against frequency f in MHz for the test piece shown in FIG. 5, without matching;

FIG. 11 is a plan view of a practical embodiment of an RF module;

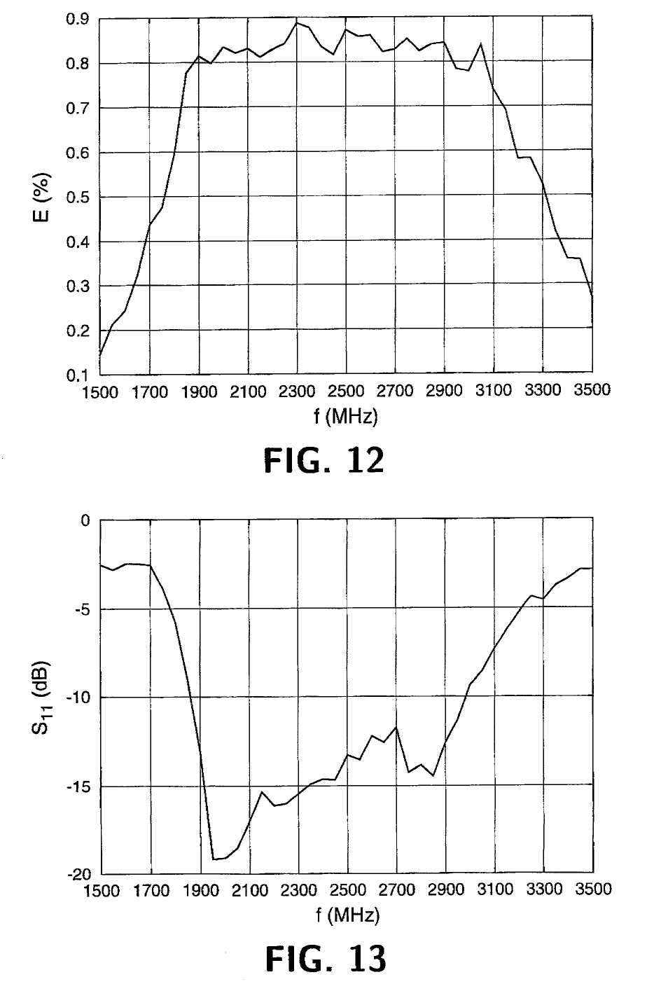

FIG. 12 is a graph of measured efficiency E against frequency f in MHz for the RF module shown in FIG. 11; and

FIG. 13 is a graph of measured return loss S₁₁ in dB against frequency f in MHz for the RF module shown in FIG. 11.

In the drawings the same reference numerals have been used to indicate corresponding features.

Our co-pending International patent application WO 02/13306 (Applicant's reference PHGB010056) discloses an antenna arrangement in which the case of a wireless terminal, or another ground conductor forming part of the terminal, is fed via an appropriate matching network and acts as an efficient, wideband radiator. The whole contents of this application are incorporated herein as reference material.

In summary, the combination of an antenna and a wireless terminal (for example a mobile phone handset) can be regarded as an asymmetrical dipole. FIG. 1 shows such a model of the impedance seen by a transceiver, in transmit mode, in a wireless handset at its antenna feed point. The first arm 102 of the asymmetrical dipole represents the impedance of the antenna and the second arm 104 the impedance of the handset, both arms being driven by a source 106. As shown in the figure, the impedance of such an arrangement is substantially equivalent to the sum of the impedance of each arm 102,104 driven separately against a virtual ground 108. The model is equally valid for reception when the source 106 is replaced by an impedance representing that of the transceiver.

It was shown in WO 02/13306 that the antenna impedance could be replaced by a physically-small capacitor coupling the antenna feed to the handset. In one embodiment the capacitor was a parallel plate capacitor having dimensions of 2×10×10 mm on a handset having dimensions of 10×40×100 mm. By careful design of the handset, the resultant bandwidth could be much larger than with a conventional antenna and handset combination. This is because the handset acts as a low Q radiating element (simulations show that a typical Q is around 1), whereas conventional antennas typically have a Q of around 50.

A problem with the use of a parallel plate capacitor to couple a transceiver to a ground plane is that it requires a significant volume (even if this volume is much less than that needed for a PIFA). As part of the current trend towards ever-smaller wireless terminals, low-profile modules are being developed including the RF circuitry required for a device (such as a mobile phone or Bluetooth terminal). Such modules are typically shielded by being enclosed in a metallic container, although such shielding is not always necessary. The addition of a capacitor plate of the dimensions indicated above can more than double the volume occupied by such a module by doubling its height, which is undesirable.

In a device made in accordance with the present invention, RF power is fed from a transceiver to a ground plane across a slot in the ground plane. This arrangement is illustrated with reference to FIGS. 2 and 3, which are respectively plan views of a RF module mounted on a ground conductor and of an RF module comprising a slotted ground plane. An RF module 206 is mounted on a Printed Circuit Board (PCB) having a rectangular ground plane 202 with a rectangular cut-out 204 (shown dashed). The module 206 also comprises a ground plane 302, having dimensions slightly larger than the cutout 204 to enable the two ground planes 202,302 to be electrically connected. The module's ground plane 302 incorporates a slot 304 which is approximately a quarter wavelength long at the operational frequency of the module 206. The module includes RF circuitry 306 (not shown in detail) and a connection 308 to the side of the slot 304 remote from the RF circuitry.

In operation as a transmitter, power from the RF circuitry 306 is fed across the slot and thence to the ground planes 302,202. In operation as a receiver, RF signals received by the ground planes 302,202 are extracted by means of the slot 304 and fed to the RF circuitry 306. Although such a feeding arrangement does not provide such a wide bandwidth as the capacitive coupling described in WO 02/13306, the arrangement still provides a wide bandwidth compared to conventional antennas, and the trade-off between volume and bandwidth will be appropriate for many applications.

The slot 304 may, as illustrated, be folded around the RF circuitry 306. It can be designed so that its resonant frequency is principally determined by the quarter wave slot resonance, while its bandwidth is determined by the combination of slot 304 and ground planes 302,202. Integration of the slot 304 in the module 206 enables tuning of its resonant frequency by varying the connections between the module's ground plane 302 and the PCB ground plane 202. Although the cut-out 204 in the PCB ground plane 202 is shown as being rectangular and of a similar size to the module 206, this is not essential. The only requirement is that the cut-out 204 is such that there is no metallisation on the PCB immediately beneath the slot 304 (and in practice that the cut-out 204 is larger than the slot 304 by at least as much as production tolerances and alignment errors, so that the effective slot dimensions are determined by the dimensions of the slot 304 in the module 206, and not by the dimensions of the cut-out 204). The location of the module 206 at the edge of the PCB, as shown, is convenient since the module is relatively remote from the remaining circuitry on the PCB but it remains straightforward to make connections to the module.

Measurements were made on an embodiment similar to that illustrated in FIGS. 2 and 3, intended for use in a Bluetooth application. In this embodiment, the module 206 just comprised the RF circuitry and the slot 304 was provided in the PCB ground plane 202 (which had no cut-out 204). The module 206 was enclosed in a metallic container connected to the PCB ground plane 202, ensuring that the reference ground was shared between the RF and other components. The dimensions of the PCB ground plane 202 were 100×40 mm, and those of a volume enclosing the module 206 and slot 304 (and therefore corresponding to the volume of a module as shown in FIG. 3) were 15×13×2 mm. The folded slot 304 had a width of 1 mm and a total length of 17 mm.

The efficiency E of this embodiment was measured, with the results shown in FIG. 4 for frequencies between 2300 and 2760 MHz. It can be seen that the efficiency is greater than 50% over a bandwidth of more than 350 MHz. This is approximately double the bandwidth that could be obtained from a PIFA of dimensions 15×10×5 mm while occupying less than half the volume. A further advantage is that, unlike other planar antenna solutions, there is no need for a significant volume to be kept clear of other circuitry to avoid interfering with antenna operation.

A test piece was produced to investigate further the applicability of the present invention. FIG. 5 is a plan view of the test piece, which comprises a copper ground plane 202 having dimensions 40×100 mm on a 0.8 mm thick FR4 circuit board (with a measured dielectric constant of 4.1). A 3×26.5 mm slot 304 is provided in the ground plane, which is fed via a 2.5 mm-wide microstrip line 506 (shown dashed) on the rear surface of the PCB, connected to the edge of the slot by a via hole 508, located 3 mm from the closed end of the slot 304.

Measurements of the return loss S₁₁ of the test piece were performed, with the results shown in FIG. 6 for frequencies f between 800 and 3000 MHz. A Smith chart illustrating the measured impedance of this embodiment over the same frequency range is shown in FIG. 7. It can be seen that the 10 dB bandwidth of this embodiment is approximately 175 MHz. The lower operating frequency compared with the first embodiment is a consequence of the longer slot length, the fractional bandwidth remaining similar.

Because of the inherently wideband performance of this embodiment, the bandwidth can be further broadened by the use of a broadband matching circuit without significant loss of efficiency. The frequency response corresponds to that expected from such an arrangement, being inductive at low frequencies and capacitive at high frequencies. Hence, a series LC resonant circuit is appropriate. FIGS. 8 (return loss) and 9 (Smith chart) show the simulated response when an inductance of 5 nH and a capacitance of 1.3 pF are placed in series with the slot feed 508. The 10 dB bandwidth is increased to approximately 200 MHz, while the tuning component losses are less than 0.2 dB at the centre of the band (assuming component Q's of 50). It will be apparent that the response could be further optimised, for example by feeding the slot 304 at a slightly higher impedance level or by providing a second, parallel resonant circuit. As a useful side-effect, the bandwidth broadening circuitry also performs a useful band filtering function, reducing the filtering requirements of the RF circuitry 306. This is beneficial if other, spectrally separate, systems are present in the device, giving increased isolation.

The efficiency E of the test piece was measured, with the results shown in FIG. 10 for frequencies between 1500 and 2200 MHz. It can be seen that the efficiency is greater than 50% over a bandwidth of about 400 MHz.

FIG. 11 shows a plan view of a production embodiment of a RF module 206 made in accordance with the present invention, having overall dimensions of approximately 15×13 mm. This embodiment is manufactured by Philips Semiconductors, having a product number BGBA100, and is intended for use in Bluetooth applications. An L-shaped ground conductor 302 incorporates an L-shaped slot 304. The slot is fed via a 1.5 nH inductor connected to connection points 1102,308 and a 3 pF series capacitor connected to connection points 1104,1106. Further matching circuitry comprising a 1.3 nH series inductor and a 1.8 pF shunt capacitor is connected between the series capacitor and a 50 Ω feed. Other RF circuitry 306, not shown, is included in the area enclosed by the dashed lines. This circuitry includes a plurality of ground connections so that, when mounted on a PCB, substantially the whole of the area enclosed by the dashed lines can be considered as ground conductor.

In this embodiment the PCB ground plane is rather closer to a half wavelength in dimension than the test piece of FIG. 5, leading to significantly improved bandwidth. FIG. 12 is a graph of measured efficiency of and FIG. 13 is a graph of measured return loss S₁₁ of the module of FIG. 11, in each case for frequencies between 1500 and 3500 MHz. The module 206 was mounted with the slot 304 opening onto the long edge of a PCB having dimensions 100×40 mm, the module being located 25 mm from the short edge of the PCB. The efficiency is greater than 80% and the return loss greater than 1 OdB over a bandwidth of more than 1 GHz from 1900 to 2900 MHz. Link test measurements have demonstrated adequate performance over a distance in excess of 10 m, thereby meeting the requirements of the Bluetooth specification.

The present invention is also suitable for use in multi-band applications, for which a multi-band matching circuit would be included in the module 206. In such applications, the wideband nature of the present invention makes the provision of multi band capability much more straightforward than with narrow band antennas.

The present invention may also be used to provide polarisation diversity from a wireless terminal. Although desirable, polarisation diversity is difficult to achieve in practice because, for small antennas, the antenna and the PCB interact such that the PCB very often radiates more than the antenna itself. Thus, the polarisation is not that of the antenna but that of the PCB. This means that even if two small antennas have orthogonal orientations, the resultant radiation will have substantially the same polarisation.

Polarisation diversity can be achieved by using a slot 304 (as described above) in conjunction with a conventional PIFA. The antennas can be located within the same volume (a very small RF module) but have substantially different polarisations. This is because the slot 304 is embedded in the PCB rather than being fed against it. The PIFA will have the polarisation of the PCB, while the polarisation of the slot 304 will depend on its orientation within the PCB. This can be arranged to provide orthogonality, which can be at least partially achieved without modification of the PIFA or notch. If the two antennas couple too strongly a switch may also be provided across the notch when the PIFA is receiving.

As described above, the slot 304 can either be incorporated into the ground plane 302 of an RF module 206 or a PCB ground plane 202. In the latter case, the RF components may or may not be provided in the form of a module 206. An advantage of incorporating the slot 304 in the module 206 is that the feed can be more precisely controlled, while matching, bandwidth broadening and/or multi-band operation can be realised in a well-controlled manner. It can be seen that there are significant advantages in fabricating an integrated module, which can then be connected to a PCB ground plane for improved radiation performance.

References above to an RF module 206 do not preclude the inclusion of other non-RF components in a module, such as for example baseband and device control circuitry. In the embodiments shown above, the slot 304 was open-ended. However, slots closed at both ends can equally well be used if fed in a balanced manner.

From reading the present disclosure, other modifications will be apparent to persons skilled in the art. Such modifications may involve other features which are already known in the design, manufacture and use of radio communications devices and component parts thereof, and which may be used instead of or in addition to features already described herein.

In the present specification and claims the word “a” or “an” preceding an element does not exclude the presence of a plurality of such elements. Further, the word “comprising” does not exclude the presence of other elements or steps than those listed.

1. A radio communications device comprising a ground conductor incorporating a slot, and means for coupling a transceiver to the slot, thereby enabling the ground conductor to function as an antenna.

2. A device as claimed in claim 1, characterised in that the ground conductor, transceiver and slot are integrated in a module which is adapted for connection to a further ground conductor.

3. A device as claimed in claim 2, characterised in that the module is enclosed in a conducting container.

4. A device as claimed in claim 2, characterised in that the module further comprises matching circuitry.

5. A device as claimed in claim 4, characterised in that the matching circuitry is adapted for dual band matching.

6. A device as claimed in claim 2, characterised in that means are provided for varying the connection area between the ground conductor and further ground conductor, thereby altering the operational frequency of the device.

7. A device as claimed in claim 1, characterised in that the slot is folded or meandered.

8. A device as claimed in claim 1, characterised in that the further ground conductor is a printed circuit board ground plane.

9. A device as claimed in claim 1, characterised in that the further ground conductor is a handset case.

10. A device as claimed in claim 1, further comprising a planar inverted-F antenna, characterised in that the polarisations of the ground conductor and the planar antenna are significantly different.

11. A radio communications apparatus including a device as claimed in claim 1.
